(19) United States
(12) Patent Application Publication
(10) Pub. No.: US 2013/0289872 A1
(43) Pub. Date: Oct. 31, 2013

(54) NAVIGATION SYSTEMS AND METHODS

(71) Applicant: Jonathan Segev, Tel Mond (IL)

(72) Inventor: Jonathan Segev, Tel Mond (IL)

(21) Appl. No.: 13/977,594

(22) PCT Filed: Dec. 19, 2011
(86) PCT No.: PCT/US11/65877

§ 371 Date: Jun. 28, 2013

(51) Int. Cl. G01C 21/34

(52) U.S. Cl. CPC G01C 21/34
USPC 701/467; 701/408

(57) ABSTRACT

Navigation systems and methods are provided that determine navigation data in one of a first or second accuracy mode based at least partly on proximity to waypoints along a route designated as either a first accuracy location or a second accuracy location.

### FIELD OF THE INVENTION

The present disclosure relates to navigation systems and methods.

### BACKGROUND OF THE INVENTION

Navigation systems, such as satellite navigation systems, are commonly used to determine a general location of the user, to determine a route to a destination location, to navigate to that destination location, or to log a route taken. One example of a navigation system uses a global navigation satellite system (GNSS), such as the Global Positioning System (GPS), and receives satellite signals broadcast from multiple satellites. Navigation systems often include receivers carried by, for example, a user or a vehicle as the user or vehicle moves. These navigation system receivers may receive navigation signals from satellites, wireless fidelity (Wi-Fi) access points (APs), and inertial sensors; process the navigation signals to obtain navigation data, such as estimated position of the receiver; and provide the navigation data, navigation data log, or navigation instruction based on the navigation data to the user. Navigation instruction may be provided by displaying a navigation route with an approximate receiver (i.e., user or vehicle) location on a map using a map application. The navigation data log can be provided as raw navigation data or navigation data stamped with a differential or an absolute time stamp.

Achieving desired accuracy with navigation systems has been an ongoing challenge. GNSS and Wi-Fi sourced navigation data may include errors caused by various effects such as the effect of the atmosphere on the satellite signals, clock accuracy, and multipath errors caused by reflected radio frequency (RF) signals. Furthermore, inertial navigation based data may include random walk, quantization, and bias errors. Thus, the estimated positions of the receiver, as determined from processing the various navigation and position determination sources, may vary from the actual absolute positions of the receiver. The resulting route determined for the receiver from this noisy position stream can vary erratically and may appear to jitter when displayed on a map grid, such as city streets, even though the user or vehicle carrying the receiver may be traveling in a straight line. To improve performance and user experience, a combination of the various sources is used to lessen the shortcoming of one method or another and to provide a hybrid position. For example, in a data logging system where a user or vehicle is using a position logging system to evaluate the user or vehicle position and associated physical parameters (velocity, acceleration/deceleration, angular stance), the various sources of position data are not required for the vast majority of the time, but mainly in specific vicinities, and near and around corners, chicanes, and other types of physical features of roads or racetracks. Furthermore, map applications that display the approximate receiver location often correct or snap the approximate receiver location to the map grid based on the proximity of the estimated current position to the map grid.

Although snapping the approximate receiver location to a map grid and improving the tracking by performing interpolation or extrapolation processes may improve user experience, problems may occur when the discrepancy between the estimated position and the actual absolute position of the navigation system receiver is relatively high due to low accuracy of the navigation system. When a user or vehicle approaches a waypoint, for example, and deviates from an established navigation mute, the lower accuracy may cause the system to have a substantial latency between the actual deviation from the route and the identification or detection of the deviation by the receiver. In particular, a map application may assume that the deviation of the estimated position from the navigation route is a result of an inaccurate position measurement and thus initially may snap the receiver location to the grid along the navigation route as if the receiver is following the navigation mute. The deviation may eventually be identified but the delay, which may be substantial, in identifying the deviation caused by the lower accuracy may prevent the user or vehicle from making a correction in a timely manner, resulting in the calculation of a new navigation route. In addition, where the navigation route tracks a certain road, the navigation system may snap to the wrong road on the map due to inaccuracies in determining the current position. For example, near intersections of two roads or when two roads run parallel to each other in relative proximity, a map application of the navigation system, based on imprecise or inaccurate navigation data, may snap to the wrong road.

Navigation system receivers may use various signal and data processing techniques to improve the accuracy of the estimated position and associated characteristics of the receiver relative to an actual absolute condition of the receiver. Signal and data processing techniques that improve accuracy and precision, however, may also require more processing power and pose increased memory requirements. Therefore, providing a more precise and accurate system may result in a more expensive navigation system. Furthermore improved precision and accuracy may increase power consumption in the navigation system receiver. To produce relatively lower cost navigation systems without requiring high processing capability or relatively high memory may result in a lower precision and accuracy in the navigation data and may, therefore, result in at least some of the problems identified above.

### BRIEF DESCRIPTION OF THE FIGURES

Reference will now be made to the accompanying drawings, which are not necessarily drawn to scale, and wherein:

FIG. 1 is a simplified schematic diagram illustrating an example satellite-based navigation ecosystem that can be operated in accordance with illustrative embodiments of the invention.

FIG. 2 is a simplified block diagram illustrating an example navigation system of the navigation ecosystem of FIG. 1 that can be operated in accordance with illustrative embodiments of the invention.

FIG. 3 is a detailed block diagram illustrating the example navigation system of FIG. 1 that can provide navigation information at more than one frequency in accordance with illustrative embodiments of the invention.

FIG. 4 is a flow diagram illustrating an example method of operating the navigation system of FIG. 3 using a waypoint-specific and location-aware accuracy adjustment in accordance with illustrative embodiments of the invention.

FIG. 5 is a representation of an example navigation map illustrating the operation of the navigation system of FIG. 4 using a waypoint-specific navigation information accuracy adjustment in accordance with illustrative embodiments of the invention.

### DETAILED DESCRIPTION OF EMBODIMENTS OF THE INVENTION

Embodiments of the invention are described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention may provide systems and methods for variable sampling of navigation signals and, as a result, variable accuracy of navigation information. In a navigation system and method, consistent with embodiments presented in the present disclosure, location-aware adjustments may be made to the accuracy or the precision of the navigation or positioning system by changing at least one accuracy setting of a navigation system receiver in response to at least one characteristic of a navigation route and an estimated current position of the receiver. By providing location-aware or condition-aware accuracy adjustments, the accuracy may be increased when a higher accuracy is desired and may be decreased when a lower accuracy is sufficient based on the receiver location. A higher accuracy setting may be used, for example, when the estimated current position of a navigation system receiver is within the vicinity of a waypoint designated as a high accuracy waypoint. A higher accuracy setting may further be used for certain conditions, such as a particular determined acceleration, deceleration, or velocity. Furthermore, the high accuracy setting may be utilized only if it is determined that there are enough system resources to support the high accuracy setting. In one aspect, the system resources may include processing capacity, buffer capacity, or the like. In another aspect, the system resources may vary with time. Additionally, a lower accuracy setting may be used at other times so that the navigation system does not always have to be in a high accuracy mode requiring greater processing power, greater energy consumption, and greater electronic memory capacity. Thus, the precision and accuracy of a navigation system can be increased only when desired, thereby limiting the time at which the receiver samples the navigation signal and generates navigation information at a relatively higher frequency. In certain other embodiments, there may be more than two accuracy modes corresponding to more than two different rates at which navigation information can be generated.

Further, a mechanism for providing navigation information at a relatively higher frequency during select times and locations and at a relatively lower frequency during other times, locations, and conditions can be provided. Certain embodiments can include determining locations where precision and accuracy can be improved by sampling the navigation signals and providing navigation information at a relatively higher frequency and at locations where such techniques may not be desired. In one aspect, one or more buffers may be provided to store the positioning signals if the positioning signals are sampled at a frequency greater than the rate at which the signals are processed. In another aspect, the sampling frequency of the navigation system, and therefore the precision and accuracy of the system, may be determined based upon both proximity to particular waypoints and on the filling level of the one or more buffers. In yet other aspects, the navigation system may be able to provide high precision and accuracy navigation information when it is deemed by a higher level application that high accuracy navigation information is desired.

As used herein, “estimated current position” generally refers to the determined or calculated position of a navigation system receiver as defined using known coordinates such as World Geodetic System (WGS) coordinates (e.g., WGS 84) or relative coordinates (e.g., identification of a WiFi AP by its SSID). The estimated current position has some degree of conformance with an actual absolute position/s of the navigation system receiver but may not be the same as the actual absolute position. As used herein. “accuracy” generally refers to the degree of conformance between an estimated current position, velocity, and time determined by a navigation system receiver and an actual absolute position, velocity, and time, and “accuracy setting” or “accuracy mode” generally refers to a setting, such as a signal or data processing parameter, within a navigation system receiver, which affects the accuracy of the navigation system receiver. As used herein, “location-aware adjustment” generally refers to an adjustment or change that is made to the accuracy of a navigation system receiver in response to or based at least in part on a particular estimated current position of a navigation system receiver. As used herein, “position” generally refers to the current position of the navigation or positioning system.

As used herein, “navigation route” generally refers to a defined series of points between an estimated current position of a navigation system receiver and a destination location. As used herein, “waypoint” generally refers to a point along a navigation route. In some cases, at a waypoint, a user or vehicle may change course, and the change in course may include, but is not limited to, a junction, an intersection, an interchange, a turn, a curve, a rotary, a section of road in proximity to another road, a roundabout, or combinations thereof. In other cases, at a waypoint, a user or aircraft may change course, and the change in course may include, but is not limited to, an airport, a military base, a restricted airspace, a city, a mountain, a tall structure, or an international border.

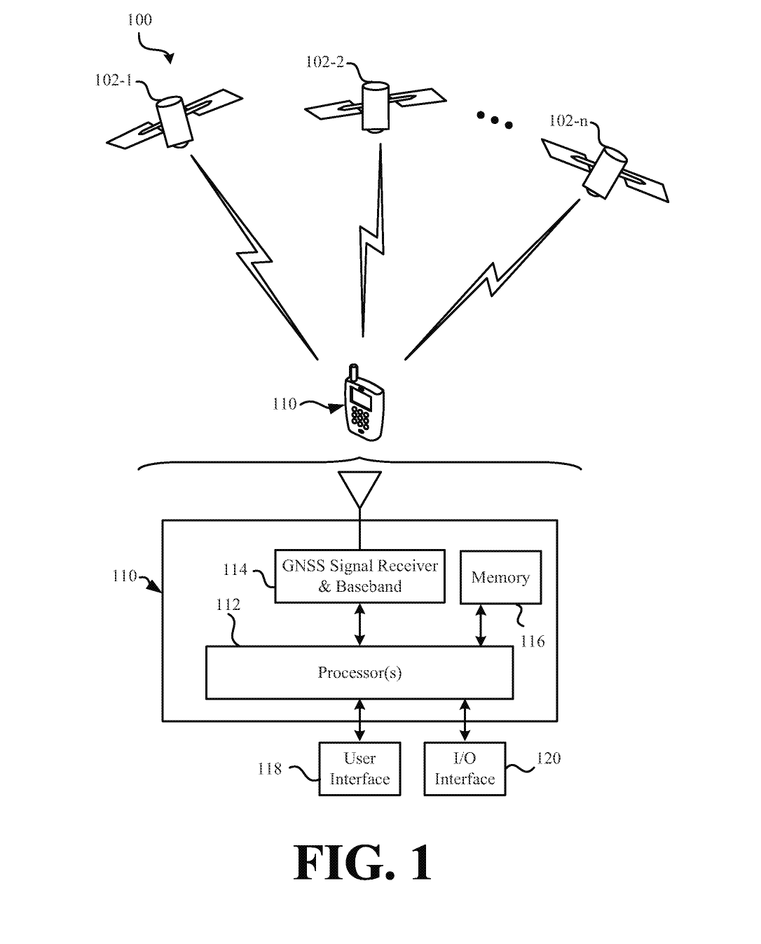

Referring now to FIG. 1, location-aware accuracy adjustments may be implemented in a navigation system 110 used in a global navigation satellite system (GNSS) 100 in accordance with embodiments of the invention. The GNSS 101) may be any one of known current GNSS or planned GNSS, such as the Global Positioning System (GPS), the GLONASS System, the Compass Navigation System, the Galileo System, or the Indian Regional Navigational System. The GNSS 100 can include a plurality of satellites 102-1 to 102-n broadcasting radio frequency (RF) signals including satellite transmission time and position information. The satellite RF signals received from three or more satellites 102-1 to 102-n may be used by the navigation system 110 to obtain navigation data using known GNSS or GPS signal and data processing techniques, as described in greater detail below. Although only three satellites 102-1 to 102-n are shown for purposes of simplicity, the GNSS 100 may include many more satellites (e.g., 24 GPS satellites) orbiting the earth, for example, in a low earth orbit (LEO) to allow broad coverage.

An embodiment of the navigation system 110 can receive satellite signals from the three or more satellites 102-1 to 102-n and can process the satellite signals to obtain satellite transmission time and position data. The navigation system 110 can process the satellite time and position data to obtain measurement data representative of measurements relative to the respective satellites 102-1 to 102-n and can process the measurement data to obtain navigation information representative of at least an estimated current position of the navigation system 110. In one embodiment, the measurement data can include time delay data and/or range data, and the navigation information can include one or more of position, velocity, acceleration, and time for the navigation system 110.

While FIG. 1 depicts the navigation signal source as GNSS from satellites 102-1 to 102-n, the navigation signal with location and/or time information may be obtained from any suitable source including, but not limited to. WiFi APs, inertial navigation sensors, or combinations thereof. The inertial navigation sensors may include, for example, accelerometers or gyros, such as micro-electromechanical systems (MEMS) based accelerometers. For illustrative purposes, the remainder of the disclosure will depict the navigation signal source as GNSS from satellites, but it will be appreciated that embodiments of the disclosure may be implemented utilizing any suitable source of navigation signal. In certain embodiments, multiple sources of navigation signals may be utilized by the systems and methods described herein.

The navigation system 110 may further process the navigation data to establish a navigation route to a destination location and to provide instructions to a user for navigating the navigation route based on the estimated current position of the navigation system 110. In some embodiments, the navigation system 110 may display the navigation route on a predefined map with an approximate location of the navigation system 110 relative to the map grid, and may notify the user when the approximate navigation system 110 location deviates from the navigation route.

The navigation system 110 may also adjust or change one or more accuracy settings in the navigation system 110 in response to one or more characteristics of the determined navigation route and/or the estimated current position. In particular, the navigation system 110 may change 310 the accuracy setting from a first accuracy setting to a second accuracy setting at locations along the navigation route. The first accuracy setting may provide navigation information with relatively higher accuracy than the second accuracy setting. In one aspect, the navigation system 110 may determine locations or waypoints along a determined navigation route where relatively higher accuracy is desired for navigation purposes. According to one non-limiting example, a location where higher accuracy may be desired is within the vicinity of a waypoint (referred to as a higher accuracy waypoint) along the navigation route where a relatively high accuracy without latency is needed to follow the route, such as near a road interchange.

With continuing reference to FIG. 1, the navigation system receiver 110 can include one or more processors 112 coupled to a front-end satellite signal receiver and baseband 114 and coupled to memory 116. The signal receiver and baseband 114 receives, samples, and processes the satellite signals to obtain the time and position information from the satellite signals. The processor(s) 112 handle data processing to obtain the measurement data and navigation data, to determine navigation routes, and to provide navigation instructions. The memory 116 may store the instructions and data for processing while the processor(s) 112 execute the instructions to process the data. The memory 116 may also store and retain data, such as the navigation data, navigation routes, map data, and software such as application software.

The satellite signal receiver and baseband 114 may be of any known type. While any known satellite signal receiver and baseband 114 may be suitable, one example implementation may include an antenna, a low noise amplifier (LNA), additional signal amplifiers, an analog to digital (A/D) converter, one or more buffers, and digital baseband. In particular, the satellite signal receiver and baseband 114 may receive a scheduling control signal to control the sampling rate of the satellite signal receiver and baseband 114.

The processor(s) 112 may include, without limitation, a central processing unit (CPU), a digital signal processor (DSP), a reduced instruction set computer (RISC), a complex instruction set computer (CISC), or any combination thereof. The navigation system 110 receiver may also include a chipset (not shown) for controlling communications between the processor(s) 112 and one or more of the other components of the navigation system 110. In one embodiment, the navigation system 110 may be based on an Intel Architecture system, and the processor(s) 112 and chipset may be from a family of Intel® processors and chipsets, such as the Intel® Atom® processor family. The processor(s) 112 may also include one or more processors as part of one or more application-specific integrated circuits (ASICs) or application-specific standard producta (ASSPs) for handling specific data processing functions or tasks.

The memory 116 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

The navigation system 110 may also include a user interface 118 and an input/output (I/O) interface 120. The user interface 118 may include, for example, one or more keys and a display, a touchscreen, or other hardware and/or software elements capable of providing input from a user and output to a user. The I/O interface 120 may include, for example, a wireless interface for connecting to a wireless network or device (e.g., using Wi-Fi or Bluetooth protocols) or a wired interface for connecting to a network or device (e.g., using a USB connection and protocol).

Although the navigation system 110 is shown as a handheld unit, a navigation system receiver with location-aware accuracy adjustment may take other forms. For example, a navigation system receiver with location-aware accuracy adjustment may be worn by a user or may be carried by a vehicle. The navigation system receiver may be a dedicated device in a vehicle or may be integrated into another electronic device or system such as, for example, a mobile phone, a smart phone, a watch, a tablet computer, a laptop computer, a personal digital assistant (PDA), a personal computer (PC), or the like. The satellite signal receiver and baseband 114 may also be provided as a separate GNSS signal receiver unit, which may be connected to a separate processing unit such as, for example, a general-purpose computer programmed to perform the data processing functions.

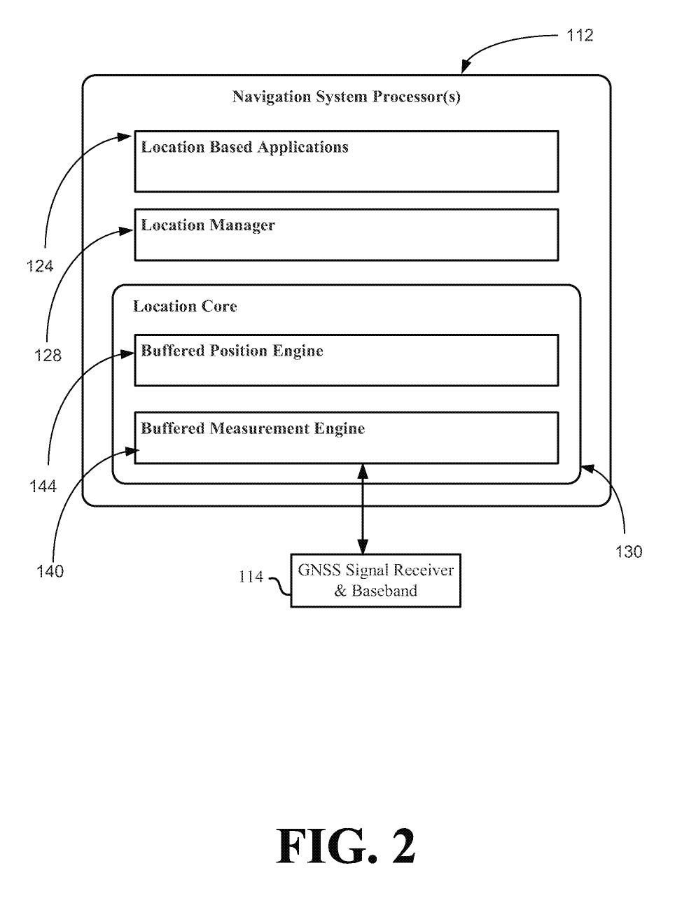

Referring now to FIG. 2, the navigation system processing within the processor(s) 112 can include one or more location based applications 124 interacting with a location manager 128 that provides the one or more location based applications with navigation information. The location manager 128 can further receive navigation information from a location core 130 that can include a buffered measurement engine 140, receiving GNSS signal(s) from the satellite signal receiver and baseband 114, as described with reference to FIG. 1. The location manager 128 can further include a buffered position engine 144 that can receive a processed signal from the buffered measurement engine 140, generate navigation information from the processed signal, and provide the navigation information to the location manager 128. As shown, the functions of the location based applications 124, the location manager 128, and the location core 130 can be implemented as software running on the processor(s) 112.

In particular, the buffered measurement engine 140 may calculate delay measurements using the transmission time obtained from the satellite signals and the reception time at the signal receiver and baseband 114. The delay measurements may be used by the buffered measurement engine 141) to calculate range measurements such as, for example, pseudo-range measurements. Pseudo-range generally refers to a range calculation from the navigation system 110 to a satellite, such as satellite 102-1-n. Pseudo-ranges may be calculated by the buffered measurement engine 140 to each satellite 102-1-n from which a satellite signal is received. In one aspect, a pseudo-range can be determined by multiplying the delay measurements of each of the satellites 102-1-n from which signals are received by the speed of light. The buffered position engine 144 may receive the pseudo-range measurements from the buffered measurement engine 140 and determine navigation information from the same. Therefore, the buffered position engine 144 may perform various mathematical manipulations of the pseudo-range data corresponding to one or more satellites 102-1-n, such as triangulation, to provide navigation information. For example, the buffered position engine 144 may perform triangulation using three different pseudo-ranges to provide two-dimensional position information, such as latitudinal and longitudinal coordinates. As a further example, the buffered position engine 144 may perform triangulation using four different pseudo-ranges to provide three-dimensional position information, such as latitudinal, longitudinal, and altitudinal coordinates.

The location manager 128 may provide a framework for making location based information or navigation information available to various location based applications 124. In one aspect, there may be an application programming interface (API) between the location manager 128 and the location based applications 124. In certain embodiments, the location manager 128 may be an operating system running on the processor(s) 112 that can provide location based information or navigation information. Example operating systems may include, but are not limited to, Google® Android®, Apple® iOS®, Microsoft Windows Mobile®, Microsoft® Windows 7, or the like. In certain other embodiments, the location manager 128 may be a software component of an operating system. In yet other embodiments, the location manager 128 may be a stand alone application that receives navigation information from the location core 130.

The location based application 124 can be any known application that can receive and use navigation information such as position information. As a non-limiting example, the location based application 124 can be a navigation tool that displays the current estimated position based on the navigation information received from the buffered position engine 144 overlaid on a map grid. The navigation tool may further provide the functionality of snapping the current location to a road on the map. Alternatively, the navigation tool may snap to a shipping route, a flight route, or any other predetermined pathways that may be available to the navigation system 110. Additionally, the navigation tool may generate and provide a navigation route to travel from the estimated current position to a destination position that is identified by a user of the navigation system 110. The maps and map grids may include at least one of cartographic or geographic data. The map and map grids used by the navigation tool may further be stored on the memory 116. The route, map, and current estimated location may be displayed by the navigation tool on the user interface 118, such as a touch screen. Therefore, the location based application 124 can provide navigation capability for vehicles, aircrafts, boats, and other forms of transportation.

Another non-limiting example of a location based application 124 may be a social networking application that receives location information from the location manager 128 and provides postings on a social networking website of the current location of the user of the navigation system 11). The social networking application may further locate points of interest in proximity of the estimated current position and use such information to allow the user of the navigation system 110 to select his or her exact location as one of the relatively proximate points of interest. Information about points of interest may be stored on the memory 116 or received from the worldwide web via I/O interface 120. Therefore, the location based application 124 can provide various forms of geo-tagging capability.

Without providing an exhaustive set of example location based applications 124, it can be appreciated that location based applications can use navigation information for various forms of entertainment, gaming, documentation, geo-tagging, scientific applications, various forms of navigation, safety monitoring of transportation vehicles, monitoring of migratory patterns of animals, and the like.

Although described with a particular hardware and software configuration, the functional elements in FIG. 2 may be implemented using any suitable combination of hardware and software. In some embodiments, for example, one or more of the functional elements, or portions of the functional elements, may be implemented using one or more general-purpose processors executing software instructions. In other embodiments, one or more of the functional elements or portions of the functional elements may be implemented using one or more ASICs or ASSPs designed specifically to perform the functions.

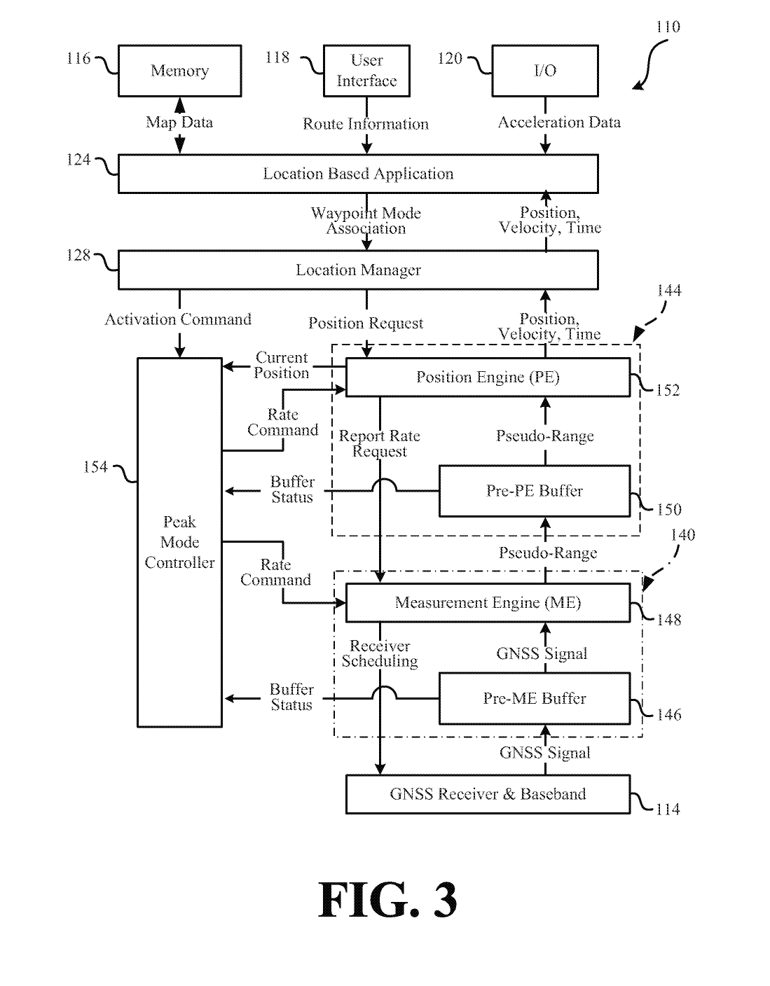

Referring now to FIG. 3, the functional interaction of each element during operation of the navigation system 110, in accordance with embodiments of the invention, is described in greater detail. As shown, the location based application 124, such as a navigation tool, can interact with the memory 116 to request and receive map data. The location based application 124 can also interact with the user interface 118 to receive input from a user such as, for example, route information or a destination location. The location based application 124 may optionally also receive sensor data, such as acceleration data via I/O port 120. The location based application 124 also receives navigation information from the location manager 128.

The location based application 124 may, in one aspect, request a particular map data from a map database stored on the memory 116, based on input from the user interface. For example, if the user desires to travel from a starting point or current location in Southern Tel Aviv, Israel, to a destination point in Northern Tel Aviv, Israel, the location based application 124 may request, in particular, a map of Tel Aviv, Israel, rather than loading all of the maps that may be available in the map database stored in the memory 116.

The location based application 124 may further determine a route based on a current location of the navigation system, the destination point, and the map data. For example, for road based transportation, the location based application may determine a route between the present location and the desired destination location according to, for example, the fastest routes, the shortest routes, routes that minimize road tolls, or the like. Therefore, in certain aspects, the maps may include additional data such as road tolls, speed limits, time of day based probable road speeds, road construction, and the like. A map with a current location overlaid on the map generated by the location based application 124 may be displayed on the user interface 118, such as on a display screen. The location based application 124 may further provide navigation instructions to the user based on an estimated current position, for example, by highlighted routes on the user interface 118, via audio output from the user interface 118, or the like.

The approximate navigation system 110 location may be, in certain embodiments, displayed on the map with the navigation route, by snapping the approximate receiver location to the map grid. If the estimated current position of the receiver is within a predefined distance of a location on the map grid, for example, the location based application 124 may assume that the receiver is at that location on the map grid and may display the navigation system 110 (i.e., the user or vehicle) at that map grip location. The location based application 124 may provide navigation instructions to the user, for example, by notifying the user of waypoints along the navigation route and by notifying the user when the approximate receiver location on the map grid deviates from the navigation route. In other embodiments, the location based application 124 may provide navigation instructions to other applications, systems, or devices (e.g., in a navigation-guided vehicle).

The sensor data, such as acceleration data, may additionally be used by the location based application to determine inertial location based position estimations. These estimations may provide supplemental navigation information to the location based application. In other words, the sensor data may be used instead of, or in conjunction with, GNSS signals as a source of time and/or location information. These inertial navigation methods may further be useful, for example, if a vehicle is travelling through a tunnel, and GNSS signals are not available to the navigation system 110. Therefore, in this example scenario, the approximate location of the navigation system may be estimated by the location based application 124 based on the last known location of the navigation system 110 and acceleration data. The location based application, may, in one aspect, mathematically manipulate the acceleration data to estimate current position, such as by performing a double integral of a particular coordinate of the acceleration data.

The location based application 124 may use the determined route based on map data and user input to identify waypoints and associate each waypoint with a particular accuracy mode. The location based application 124 may, for example, designate high accuracy mode waypoints at a junction, an intersection, an interchange, a turn, a curve, a rotary, a section of road in proximity to another road, a roundabout, or the like.

In certain embodiments, the location based application 124 may also be responsible for activating and deactivating the location-aware accuracy adjustment and may receive user inputs to configure the location-aware accuracy adjustment according to user preferences. The location-aware accuracy adjustment may be configured, for example, by determining how and when accuracy settings are adjusted. When accuracy settings are adjusted within the vicinity of waypoints, for example, the user may configure the high accuracy waypoints by inputting or selecting waypoints or types of waypoints that will trigger the change to a higher accuracy setting. The user may also configure the sensitivity of the location-aware accuracy adjustment, for example, by configuring the predefined distance from a higher accuracy waypoint at which the accuracy adjustment is made. The user may further select different levels of accuracy and/or different levels of power consumption that will result in different levels of accuracy. In other embodiments, the higher accuracy waypoints and accuracy settings are configured by default or automatically by the location based application 124.

The location based application 124 may receive current locations from the location manager 128 and, if the current location is within a predetermined distance from an identified high accuracy mode waypoint, the location based application 124 may send a waypoint mode association command to the location manager 128 to indicate the mode in which navigation data should be provided. Therefore, in one aspect, during operation of the navigation system 110, the location based application 124 receives user input and map data; determines a route based, at least in part, on the user input and map data; determines one or more waypoints along the route; and ascribes one of two accuracy modes, each mode dissimilar in sampling, report rate, rate at which navigation data is received, and accuracy of the navigation system 110. The location based application 124 further determines if navigation information should be provided in one of the two modes based on the proximity of the current location to one or more of the waypoints, and requests the location manager 128 to provide navigation data in one of the two modes. Therefore, if the current location as derived from the navigation data, such as the position, velocity, time (PVT) data indicates that the navigation system is within a predetermined distance of a high accuracy waypoint, then the location based application 124 may set the current mode in a high accuracy mode and indicate the same via a waypoint mode association request to the location manager 128. In certain embodiments, the predetermined distance may be in the range of approximately 50 meters to approximately 2,000 meters.

In response to the waypoint mode association request received from the location based application 124, the location manager 128 provides a position request to the buffered position engine 144 and an activation command to a peak mode controller 154. The location manager 128 receives position, velocity, and time (PVT) data from the buffered position engine 144 at a rate corresponding to one of the two accuracy modes. For example. PVT data may be received at a relatively high rate during a high accuracy mode setting or in a relatively low rate during a normal accuracy mode setting. Therefore, changing the accuracy mode may include one or more changes in the signal and/or data processing performed by the navigation system 110, which may result in changes in the accuracy of the PVT data provided to the location manager 128 and subsequently to the location based application 124.

The buffered measurement engine 140 can include a pre-measurement engine (pre-ME) buffer 146 and a measurement engine (ME) 148, often also referred to as a tracker. The buffered position engine 144 can include a pre-position engine (pre-PE) buffer 150 and a position engine (PE) 152, often also referred to as a navigator. The pre-measurement engine buffer 146 and pre-position engine buffer 150 may each provide a buffer status to the peak mode controller 154.

The buffer status may be indicative of how full the respective buffer is. For example, the buffer status may indicate to the peak mode controller 154 what percentage of the respective buffers 146 and 150) are filled with data, such as GNSS signal data or pseudo-range data.

The peak mode controller 154 may provide a rate command to the PE 152 and the ME 148 to control the report rate, or the frequency at which navigation information is generated, based upon the activation command, and the buffer status of the buffers 146 and 150. In particular, if the activation command indicates a high accuracy mode operation and the buffer status is below a predefined threshold, then the peak mode controller 154 may provide the rate command to indicate a relatively high report rate to generate navigation data at a relatively higher frequency, corresponding to greater accuracy. In other words, the report rate, the frequency of the navigation information, and therefore the accuracy of the navigation system 110 may be relatively higher when the current location is within a predetermined distance of a high accuracy waypoint, and the buffers 146 and 150 are filled to less than a predetermined threshold. In certain embodiments, the predetermined threshold related to the buffer status may be in the range of about 75% to about 95%.

The PE 152 may be responsible for processing the measurement data to obtain position, velocity and time (PVT) data representative of an estimated position, velocity and time of the navigation system 110. In particular, the PE 152 may calculate an estimated position of the receiver using the satellite position information and the pseudo-range measurements for three or more satellites. Four or more satellites may be used to calculate an estimated position with three position dimensions (X, Y, Z) and time, although three satellites may be used to calculate the estimated position with two dimensions (X, Y). The estimated position may be converted to and represented using known World Geodetic System (WGS) coordinates (e.g., WGS 84).

The pseudo-range data is provided to the PE 152 from the ME 148 via the pre-PE buffer 150. The PE 152, based on the rate command issued by the peak mode controller 154, may provide a report rate request to the ME 148 to request that the ME 148 provide data at an appropriate rate consistent with the intended accuracy mode. The ME 148, in turn, may issue a receiver scheduling command to the GNSS receiver and baseband 114 to provide a GNSS signal at an appropriate rate for the ME 148 to generate pseudo-range data at a frequency to allow the PE 152 to provide PVT data at a frequency consistent with the desired accuracy mode. In one aspect, the receiver scheduling command may control the rate at which the GNSS receiver and baseband 114 samples the received GNSS signals from one or more satellites 120-1-n and provides the same to the pre-ME buffer 146 and subsequently to the ME 148.

Therefore, based on the location aware mode association at the location based application 124 and the buffer status of the buffers 146 and 1501 the peak mode controller 154 may issue the rate command to control the rate at which PVT data is provided by the PE 152 to the location manager 128.

In certain embodiments, the peak mode controller 154 may issue the rate command to control the rate at which PVT data is provided by the PE 152 to the location manager 128 based on the location aware mode association at the location based application 124 as well as navigation system 110 resources available. In this case, the system resources may include the status of the buffers 146 and 151), but may also include navigation system 110) processing bandwidth, memory status, or the like. Therefore, in one aspect, peak mode controller 154 may determine if there is enough system resources available to support the high accuracy mode operation, and may issue a rate command based thereon. The peak mode controller 154 may further receive an indication of system resources available to provide the rate command.

In certain other embodiments, the location manager 128 may receive an indication of system resources available and modify the activation command thereon to operate in a high accuracy mode only if the system resources would enable the same. In one aspect, the location manager 128 may therefore be informed of the status of the buffers 146 and 151), the processing bandwidth of processing elements 148 and 152, or the like.

In one aspect, when the navigation system 110 operates in a high accuracy mode, the GNSS signal may be provided by the GNSS receiver and baseband 114 at a rate greater than the rate at which the GNSS signal may be processed by the ME 148. Therefore, during high accuracy mode operation, the GNSS signal may be stored in the pre-ME buffer 146, and the pre-ME buffer 146 may continue to fill with time into a high accuracy mode operation. When the peak mode controller 154 controls the navigation system 110 in a normal accuracy mode after a high accuracy mode operation, the ME 148 may process the GNSS signal faster than the rate at which the signal is provided by the GNSS receiver and baseband 114. Therefore, the ME 148 may process the GNSS signals stored in the pre-ME buffer 146 and reduce the level of GNSS signals stored in the pre-ME buffer 146.

Similar to the pre-ME buffer 146, when the navigation system 110 operates in a high accuracy mode, the pseudo-range data may be provided by the ME 148 at a rate greater than the rate at which the pseudo-range data may be processed by the PE 152. Therefore, during high accuracy mode operation, pseudo-range data may be stored in the pre-PE buffer 150, and the pre-PE buffer 151) may continue to fill with time into a high accuracy mode operation. When the peak mode controller 154 controls the navigation system 110 in a normal accuracy mode after a high accuracy mode operation, the PE 152 may process the pseudo-range data faster than the rate at which the pseudo-range data is provided by the ME 148. Therefore, the PE 152 may process the pseudo-range data stored in the pre-PE buffer 150 and reduce the level of pseudo-range data stored in the pre-PE buffer 150.

It should be appreciated that the navigation system 110, as described, can operate beyond the processing capability of the processor(s) 112 of the system 110 for some period of time by buffering data. During normal operation, the buffered data can be processed and cleared for a subsequent peak mode or high accuracy mode operation of the navigation system 110. In other words, periods of high accuracy mode operation at the most critical times and locations may be achieved by the navigation system 110 as described, without requiring the additional processing power of the processor(s) 112 in the navigation system 110. As a result, the navigation system 110, according to certain embodiments of the invention, may require less expensive processor(s) and may be less expensive to manufacture than a system that always operates in a high accuracy mode. Additionally, the navigation system 110, according to certain embodiments of the invention, may consume less power than a system that always operates in a high accuracy mode.

It should also be noted that the layout of the navigation system 110 may be modified in various ways in accordance with certain embodiments of the invention. For example, in certain embodiments, one or more functional blocks may be eliminated or substituted with equivalent or nearly equivalent functional blocks. Additionally, in other embodiments, other elements may be added to, or may be present in, the navigation system 110.

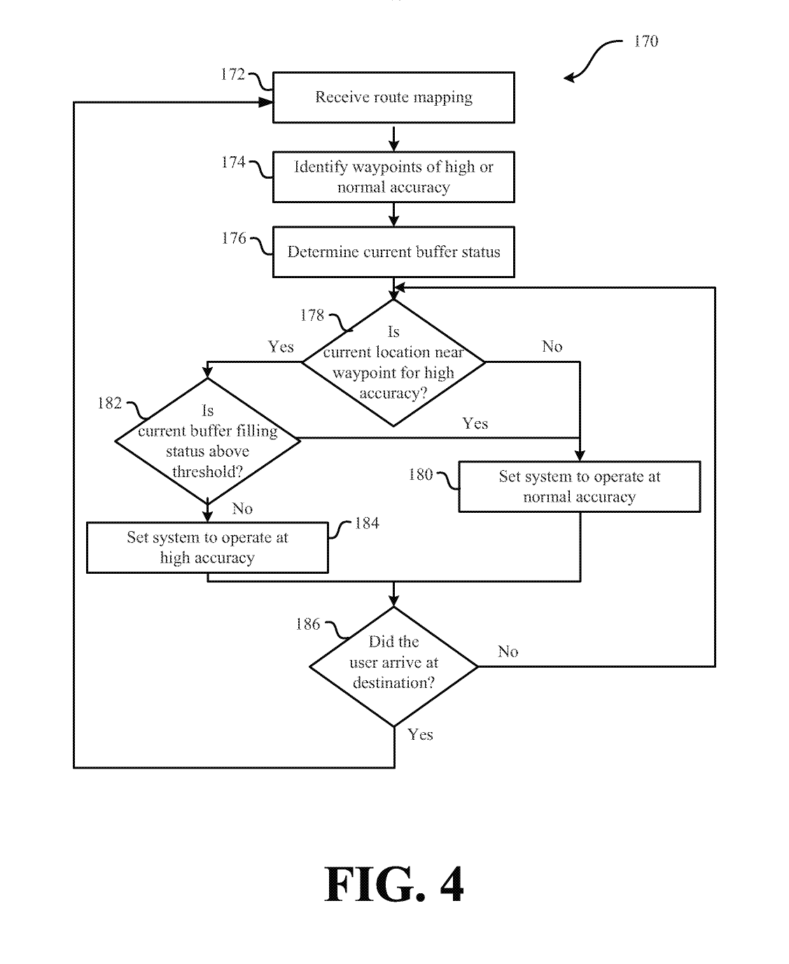

FIG. 4 illustrates a navigation method 170 with general location-aware accuracy adjustment, in accordance with embodiments of the invention. At block 172, a route mapping is received. As discussed with reference to FIG. 3, the route mapping may be generated by the location based application 124 based on user input, such as a destination location. The route mapping may be further based on the current location of the navigation system 110. The user destination data may be obtained, for example, by receiving user input from the user interface 118 of a navigation system 110 and may be in the form of an address or selected location. At block 174, waypoints of high or normal accuracy may be identified. As described earlier, the waypoints may be identified based upon locations where the location based application 124 may benefit from a high accuracy of navigation information, such as PVT data. At block 176, the current buffer status is determined. As discussed with reference to FIG. 3, there may be more than one buffer, for example, the pre-ME buffer 146 and the pre-PE buffer 150. The buffer filling status may be provided to the peak mode controller 154.

At block 178, it is determined whether the current location is near a waypoint for high accuracy. If the current location is not near a high accuracy waypoint, then at block 180, the system may operate in a normal accuracy mode. If, however, at block 178 it is determined that the current location is near a high accuracy waypoint, or in other words, within a predetermined distance of a high accuracy waypoint, then at block 182, it is determined whether the buffer filling status is above a threshold. If the buffer filling status is above the threshold, then the method 171) continues to block 180, where the navigation system operates at a normal accuracy mode. If, however, at block 182, it is determined that the current buffer filling status is not above the threshold, then the navigation system may be set to operate in a high accuracy mode at block 184. The accuracy setting may be changed to a higher accuracy mode, for example, by adjusting the signal and/or data processing rate in the ME 148 and PE 152, controlled by the peak mode controller 154, as described with reference to FIG. 3. Finally, at block 186, it is determined whether the destination or the end of the route has been reached. If the destination has not been reached, then the method 170 may return to block 178 to compare the next current location to identified waypoints. If, however, the destination has been reached as determined at block 186, then the method 170 may end and wait for the next route mapping at block 172.

It should be noted, that the method 170 may be modified in various ways in accordance with certain embodiments of the invention. For example, one or more operations of the method 170 may be eliminated or executed out of order in other embodiments of the invention. Additionally, other operations may be added to the method 170 in accordance with other embodiments of the invention.

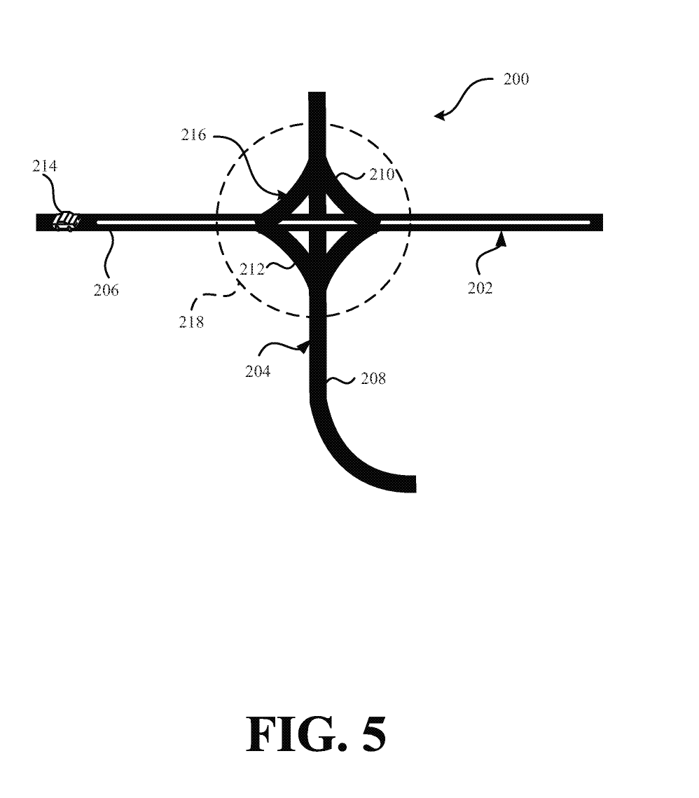

FIG. 5 illustrates an example of a map 200 that may be displayed by the navigation system 110 according to embodiments of the invention. The illustrated example of the map 200 includes highways 202 and 204, with straight stretches 206 and 208, respectively, and curved portions 210 and 212, respectively. The map 200 may further depict the location of the navigation system 110 on the map 2110, such as an image of a car 214. As long as the navigation system 110 is traveling in a straight line 206 and 208 that is not in proximity of other roads, performance of the navigation system 110 is not likely to be affected by any discrepancies due to lower accuracy between the actual position of the navigation system 110 and the estimated position provided by the navigation system 110. However, near an interchange 216 between the two highways, represented by the curved sections 210 and 212, discrepancies due to lower accuracy between the actual position of the navigation system 110 and the position estimate provided by the navigation system 110 may adversely affect the performance of the navigation system 110. Therefore, the interchange 216 may be designated as a high accuracy waypoint. Furthermore, the predetermined distance around the interchange may be represented by the boundary 218. Therefore, when the navigation system 110 is located within the boundary 218, the navigation system may be operated in a high accuracy mode.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), magneto-optical disks, semiconductor devices such as read-only memories (ROMs), random access memories (RAMs) such as dynamic and static RAMs, erasable programmable read-only memories (EPROMs, electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation. In the use of such terms and expressions, there is no intention of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method comprising:
determining a route based on user input in at least one processor;
identifying at least one waypoint by the at least one processor on the route corresponding to one of a first accuracy location or a second accuracy location;
determining navigation data by the at least one processor in a first accuracy mode or a second accuracy mode based at least partly on comparing a current position to the at least one waypoint.

2. The method of claim 1, wherein determining navigation data by the at least one processor further comprises determining the navigation data in the first accuracy mode when the current position is within a predetermined threshold of one of the at least one waypoints corresponding to the first accuracy location.

3. The method of claim 1, wherein determining navigation data in a first accuracy mode or a second accuracy mode is based at least partly on a system resource.

4. The method of claim 1, wherein determining navigation data by the at least one processor is further based on comparing a filling status of a buffer to a predetermined filling threshold.

5. The method of claim 1, wherein the predetermined filling threshold is in the range of 75% and 95% of buffer capacity.

6. The method of claim 1, wherein the at least one waypoint is identified as a first accuracy location if the at least one waypoint is within the predetermined threshold of at least one of: (i) an intersection on the route; (ii) a curve on the route; (iii) proximity of the route to other roads; (iv) an airport; (v) a military base: (vi) a restricted airspace; (vii) a city; (viii) a mountain; (ix) a tall structure; (x) an international border or (xi) a race track.

7. The method of claim 1, wherein navigation data is determined at a greater rate in the first accuracy mode than in the second accuracy mode.

8. The method of claim 1, wherein the navigation data is at least one of: (i) a position; (ii) a velocity; or (iii) an acceleration.

9. The method of claim 1, further comprising receiving a global navigational satellite signal (GNSS).

10. A system comprising:
a measurement engine repeatedly receiving at least one signal and repeatedly determining a pseudo-range measurement at one of a first and second frequency based at least partly on the at least one signal;
a position engine repeatedly receiving the pseudo-range measurement and repeatedly determining a position based at least partly on the determined pseudo-range measurement; and
a controller providing a rate command to the measurement engine to select one of the first and second frequency based at least in part upon the determined position.

11. The system of claim 10, wherein the controller selects the rate command corresponding to the first frequency if the current position is within a predetermined threshold of a waypoint corresponding to a high accuracy position.

12. The system of claim 11, wherein the first frequency is greater than the second frequency.

13. The system of claim 11, further comprising a location manager that determines the waypoint corresponding to the high accuracy position.

14. The system of claim 10, further comprising a buffer for storing at least one of: (i) the at least one signal; (ii) the pseudo-range measurement; and (iii) the position.

15. The system of claim 14, wherein the controller selects the rate command corresponding to the first frequency based in part on available system resources.

16. At least one computer-readable medium comprising computer-executable instructions that, when executed by one or more processors, executes a method comprising:
determining a route based on user input;
identifying at least one waypoint on the route corresponding to one of a first accuracy location or a second accuracy location;
determining navigation data in a first accuracy mode or a second accuracy mode based at least partly on comparing a current position to the at least one waypoint.

17. The compute-readable medium of claim 16, wherein determining navigation data further comprises determining the navigation data in the first accuracy mode when the current position is within a predetermined threshold of one of the at least one waypoints corresponding to the first accuracy location.

18. The computer-readable medium of claim 16, wherein the at least one waypoint is identified as a first accuracy location if the at least one waypoint is within the predetermined threshold of at least one of: (i) an intersection on the route; (ii) a curve on the route; or (iii) proximity of the route to other roads.

19. The computer-readable medium of claim 17, wherein navigation data is determined at a greater rate during the first accuracy mode than during the second accuracy mode.

20. The computer-readable medium of claim 17, wherein the navigation data is at least one of: (i) a position; (ii) a velocity; (iii) an acceleration; (iv) a deceleration; (vI a rotation; (vi) a radial acceleration: or (vii) a radial velocity.
